(19) United States
(12) Patent Application Publication
(10) Pub. No.: US 2017/0025082 A1
(43) Pub. Date: Jan. 26, 2017

(54) DISPLAY DEVICE

(71) Applicant: Japan Display Inc., Minato-ku (JP)

(72) Inventors: Masahiro KOBAYASHI, Tokyo (JP); Masateru MORIMOTO, Tokyo (JP); Takeshi SATO, Tokyo (JP)

(73) Assignee: Japan Display Inc., Minato-ku (JP)

(21) Appl. No.: 15/188,556

(22) Filed: Jun. 21, 2016

(30) Foreign Application Priority Data
Jul. 22, 2015 (JP) 2015-145079

(51) Int. Cl. G09G 3/36; G02F 1/1339; G02F 1/1337; G02F 1/1343; G02F 1/1333; G02F 1/1335; G02F 1/1368

(52) U.S. Cl. CPC G09G 3/3677; G02F 1/133514; G02F 1/133512; G02F 1/13394; G02F 1/1368; G02F 1/133528; G02F 1/134309; G02F 1/133345; G02F 1/133788; G02F 1/13439; G02F 2201/123; G02F 2201/121; G02F 2001/133519; G09G 2310/0289; G09G 2320/0233; G09G 2330/021

(57) ABSTRACT

According to one embodiment, a display device including, a display area and a non-display area, a first substrate, a second substrate arranged to be opposed to the first substrate, a sealant which bonds the first substrate and the second substrate, a liquid crystal layer held between the first substrate and the second substrate and sealed by the sealant, a trap electrode positioned at an inner side surrounded by the sealant and arranged in the non-display area, and a bank disposed between the sealant and the trap electrode.

### CROSS-REFERENCE TO RELATED APPLICATIONS

This application is based upon and claims the benefit of priority from Japanese Patent Application No. 2015-145079, filed Jul. 22, 2015, the entire contents of which are incorporated herein by reference.

### FIELD

Embodiments described herein relate generally to a display device.

### BACKGROUND

It is known that the display quality of a liquid crystal display device may deteriorate if ionic impurities in a liquid crystal layer condense in a display area. For example, a technology of arranging ion trap electrodes (a first electrode, a second electrode, and a third electrode) extending between a display area and a sealant, and causing the impurities to stay in a projecting portion in which an outer edge of the liquid crystal layer protrudes to a side opposite to the display area, by utilizing an electric field produced by a potential difference between the respective electrodes, is disclosed. However, recently, because of the increasing demand for making the frame of a display device narrower, it is becoming difficult to secure a space for arranging ion trap electrodes on the outer side of the display area.

### BRIEF DESCRIPTION OF THE DRAWINGS

FIG. 1 is an illustration showing the structure of a display device according to the present embodiment.

FIG. 2 is an illustration showing the structure of a pixel in a display area DA shown in FIG. 1.

FIG. 3 is a plan view showing the structure of a display panel near a first corner portion.

FIG. 4 is an illustration showing an example of the structure of a connecting portion.

FIG. 5 is an illustration showing a cross-section of the display panel including pixels in a display area.

FIG. 6 is a view showing a cross-section taken along line VI-VI′ of the display panel shown in FIG. 3.

FIG. 7 is a plan view showing a second substrate in a process of applying a curable resin composition.

FIG. 8 is a view showing a cross-section of the display panel taken along line A-A′ shown in FIG. 7, in a process of aligning a first substrate and the second substrate.

FIG. 9 is a view showing a cross-section of the display panel taken along line A-A′ shown in FIG. 7, in a UV radiation process.

FIG. 10 is a plan view showing the display panel after the curable resin composition has been cured.

FIG. 11 is a view showing a display panel of a modification in which the shape of a trap electrode is different.

FIG. 12 is a view showing a display panel of a modification in which the positions of the trap electrode and a bank are different.

FIG. 13 is a view showing a display panel of a modification in which the shape of the bank is different.

FIG. 14 is a view showing an example of the arrangement of the trap electrode and the bank.

FIG. 15 is a view showing a modification in which the trap electrodes and the banks are disposed on an end side on the opposite side of a mount.

FIG. 16 is a view showing a modification in which the trap electrodes and the banks are disposed on an end side close to the mount.

FIG. 17 is a view showing a modification in which the trap electrode and the bank are each formed integrally from a first corner portion to a second corner portion along the end side.

### DETAILED DESCRIPTION

In general, according to one embodiment, a display device including a display area and a non-display area, the display device comprising: a first substrate; a second substrate arranged to be opposed to the first substrate; a sealant which bonds the first substrate and the second substrate; a liquid crystal layer held between the first substrate and the second substrate and sealed by the sealant; a trap electrode positioned at an inner side surrounded by the sealant and arranged in the non-display area; and a bank disposed between the sealant and the trap electrode.

According to another embodiment, a display device comprising: a display panel including a display area on which an image is displayed, and a frame-shaped non-display area located around the display area; a sealant arranged in the non-display area of the display panel; a liquid crystal layer sealed within the display panel by the sealant; a mount arranged on one of short sides of the display panel; a first corner portion and a second corner portion located on a opposite side of the mount side of the display panel; a third corner portion and a fourth corner portion located on the mount side of the display panel; a first bank which is located near at least one of the first to fourth corner portions of the non-display area, and includes an aperture at a position opposed to the display area, and an outer peripheral surface which is in contact with the sealant; a first pocket area surrounded by the first bank in the liquid crystal layer; and a first trap electrode disposed in an area corresponding to the first pocket area at the non-display area.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the drawings may be more schematic than in the actual modes, but they are mere examples, and do not limit the interpretation of the present invention. Furthermore, in the description and figures of the present application, structural elements, which have functions identical or similar to the functions described in connection with preceding drawings, are denoted by the same reference numbers, and detailed explanations of them that are considered redundant may be omitted.

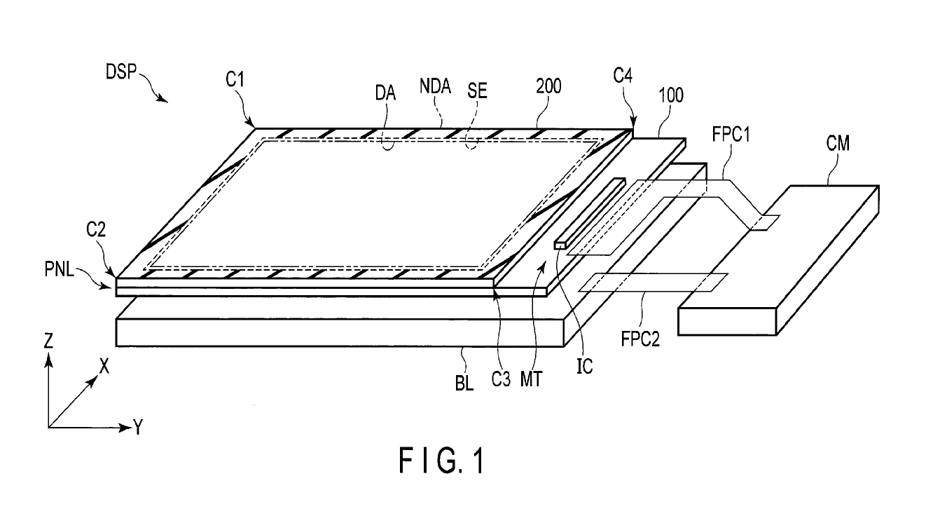

FIG. 1 is an illustration showing the structure of a display device according to the present embodiment.

A display device DSP comprises a display panel PNL, a driver IC chip IC which drives the display panel PNL, an illumination device (a backlight unit) BL which illuminates the display panel PNL, a control module CM which controls the operation of the display panel PNL and the illumination device BL, flexible printed circuits FPC1 and FPC2 which transmit control signals to the display panel PNL and the illumination device BL, and the like. In the present embodiment, a first direction X is, for example, a short-side direction of the display panel PNL. A second direction Y is the direction which crosses the first direction X, and is, in other words, a long-side direction of the display panel PNL. Further, a third direction Z is the direction which crosses the first direction X and the second direction Y. Furthermore, it is assumed that the main surface is a plane parallel to the X-Y plane defined by the first direction X and the second direction Y.

The display panel PNL comprises a first substrate 100, a second substrate 200 arranged to be opposed to the first substrate 100, a sealant SE which bonds the first substrate 100 and the second substrate 200, a liquid crystal layer (a liquid crystal layer LQ to be described later) held between the first substrate 100 and the second substrate 200 and sealed by the sealant SE. The display panel PNL includes a display area DA on which an image is displayed, and a frame-shaped non-display area NDA located around the display area DA. In the example illustrated, the display area DA is formed rectangular, but it may be formed in a different polygonal shape or another shape such as circular or elliptical.

The illumination device BL is disposed on the back surface side of the display panel PNL which is opposed to the first substrate 100. Various types of illumination devices can be applied as the illumination device BL, and the type of illumination device is not particularly limited. For example, a direct type wherein a light-emitting element such as a light-emitting diode (LED) is arranged in a plane parallel to the main surface, or an edge type wherein the light-emitting element is arranged at an end portion of a light guide plate not illustrated, may be employed.

The display panel PNL comprises a mount MT on the first substrate 100 at one of its short sides. The driver IC chip IC is mounted on the mount MT. The flexible printed circuit FPC1 is mounted on the mount MT, and connects the display panel PNL to the control module CM. The flexible printed circuit FPC2 connects the illumination device BL to the control module CM.

The display panel PNL comprises a first corner portion C1, a second corner portion C2, a third corner portion C3, and a fourth corner portion C4 at places where the first substrate 100 and the second substrate 200 are opposed to each other. The third corner portion C3 and the fourth corner portion C4 are located on the mount MT side close to the mount MT. The first corner portion C1 and the second corner portion C2 are located on the opposite side of the mount MT side, and located on a diagonal position of the third corner portion C3 and the fourth corner portion C4, respectively. Further, the first corner portion C1 is located diagonally to the third corner portion C3, and the second corner portion C2 is located diagonally to the fourth corner portion C4.

The display device DSP of such a configuration corresponds to what is called a transmissive liquid crystal display device comprising a transmission display function of displaying an image by selectively passing light incident on the display panel PNL from the illumination device BL by each pixel PX. However, the display device DSP may be what is called a reflective liquid crystal display device comprising a reflective display function of displaying an image by selectively reflecting the external light incident on the display panel PNL from the outside by each pixel PX, or a transflective liquid crystal display device comprising functions of both the transmissive and reflective liquid crystal display devices. A light source may be omitted from the reflective liquid crystal display device, or an illumination device (front light unit) may be arranged on the front surface side of the display panel PNL, which is opposed to the second substrate 200. In the following, a transmissive liquid crystal display device will be described as an example of the liquid crystal display device.

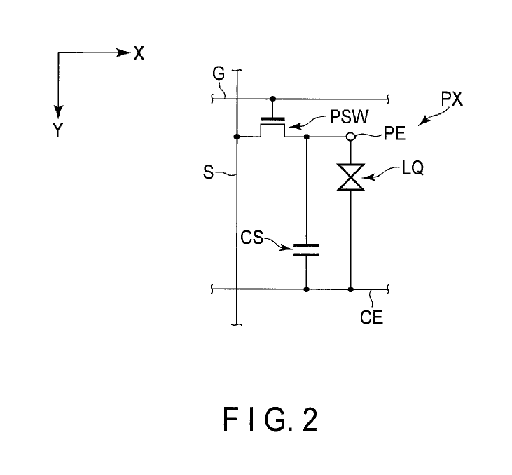

FIG. 2 is an illustration showing the structure of a pixel in the display area DA shown in FIG. 1.

Each of pixels PX comprises a switching element PSW, a pixel electrode PE, a common electrode CE, a liquid crystal layer LQ, etc. The switching element PSW is formed of, for example, a thin-film transistor (TFT). The switching element PSW is electrically connected to a scanning line G, a signal line S, and the pixel electrode PE. For example, the scanning line G extends in the first direction X, and the signal line S extends in the second direction Y. Note that the scanning line G and the signal line S may be formed straight, or at least partly curved. The liquid crystal layer LQ is driven by an electric field produced between the pixel electrode PE and the common electrode CE. A storage capacitance CS is formed between, for example, the common electrode CE and the pixel electrode PE.

Next, a structure of a pocket area PCK which accumulates ionic impurities in the liquid crystal layer LQ will be described.

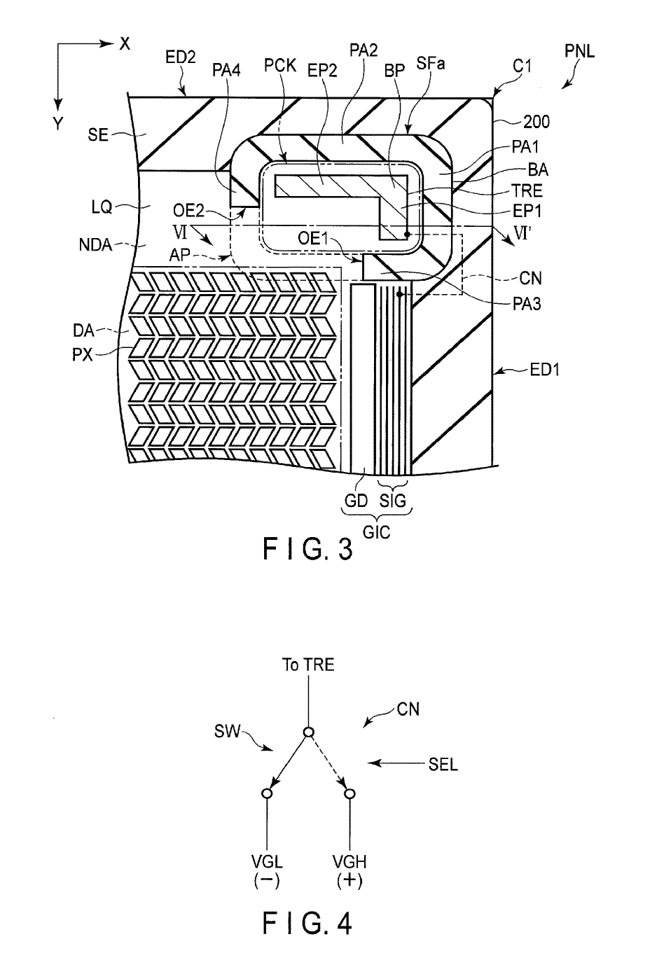

FIG. 3 is a plan view showing the structure of a display panel near the first corner portion.

The first corner portion C1 is formed of a first end side ED1 and a second end side ED2. For example, the first end side ED1 is the long side of the display panel PNL, and extends in the second direction Y. Further, the second end side ED2 is the short side of the display panel PNL, and extends in the first direction X.

The display panel PNL comprises, for example, pixels PX arrayed in a matrix in the first direction X and the second direction Y in the display area DA. Pixels PX arranged in the second direction Y extend, for example, in different directions in turn. However, the arrangement of the pixels PX is not particularly limited to the example illustrated in the drawing.

The display panel PNL comprises, for example, the sealant SE, a trap electrode TRE, a bank BA, a data supply line SIG, and a scanning line driver GD in the non-display area NDA.

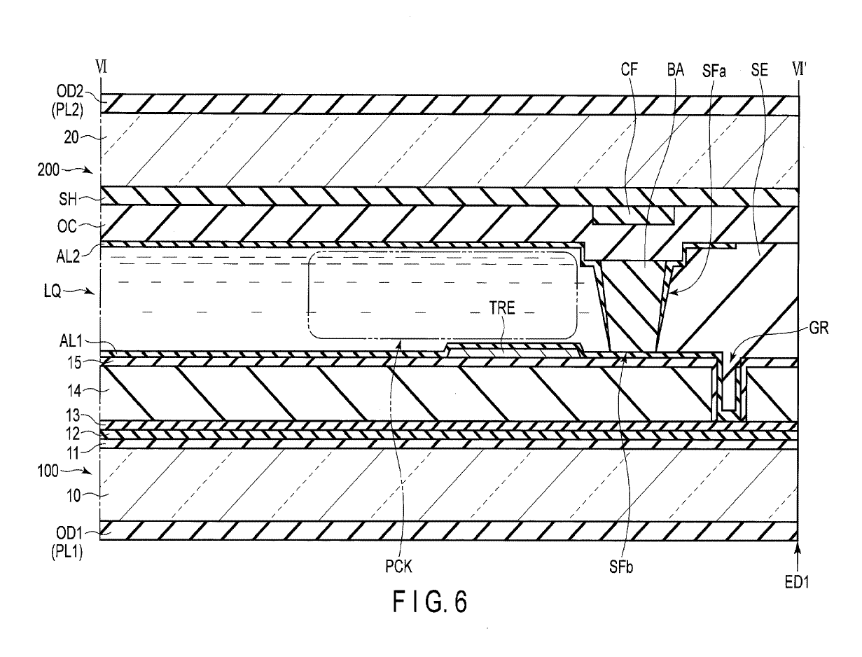

The sealant SE extends along the first end side ED1 and the second end side ED2. The trap electrode TRE is disposed at an inner side surrounded by the sealant SE, and arranged in the non-display area NDA of the first substrate 100 or the second substrate 200. Also, the trap electrode TRE is arranged near the first corner portion C1. The trap electrode TRE may be arranged on either of the substrates considered to be suitable, or arranged on both of the substrates. Note that in the example illustrated, the trap electrode TRE is disposed on the first substrate 100, as will be described later referring to FIG. 6.

For example, the trap electrode TRE is L-shaped. In the example illustrated, the trap electrode TRE comprises a bent portion BP arranged to be opposed to the first corner portion C1, a first extended portion EP1 extending parallel to the first end side ED1, and a second extended portion EP2 extending parallel to the second end side ED2. The bent portion BP corresponds to a portion where the first extended portion EP1 and the second extended portion EP2 cross each other. The first extended portion EP1 extends to be separated from the second end side ED2, from the bent portion BP. The second extended portion EP2 extends to be separated from the first end side ED1, from the bent portion BP. Note that the shape of the trap electrode TRE is not particularly limited, and the trap electrode TRE may have a shape other than the one described above, such as polygonal, circular, or elliptical. Also, the trap electrode TRE may be shaped such that it has irregularities in a direction perpendicular to the main surface, or has slits which penetrate in the direction perpendicular to the main surface.

The bank BA is disposed between the sealant SE and the trap electrode TRE. In the example illustrated, the bank BA surrounds the trap electrode TRE, and forms the pocket area PCK in the liquid crystal layer. That is, the bank BA has a first portion PA1, a second portion PA2, a third portion PA3, and a fourth portion PA4. The first portion PA1 extends in the second direction Y along the first end side ED1, and is in contact with the sealant SE. Also, the first portion PA1 is positioned between the first extended portion EP1 and the first end side ED1. The second portion PA2 extends in the first direction X along the second end side ED2, and is in contact with the sealant SE. Also, the second portion PA2 is positioned between the second extended portion EP2 and the second end side ED2. The second portion PA2 is connected with the first portion PA1 at a place between the bent portion BP and the first corner portion C1. The third portion PA3 is extended toward the display area DA from the first portion PA1. The fourth portion PA4 is extended toward the display area DA from the second portion PA2.

These third portion PA3 and the fourth portion PA4 are cut in the middle, and form an aperture AP at a position opposed to the display area DA. In one example, the aperture AP is located diagonally to where the first portion PA1 and the second portion PA2 are connected. An end portion OE1 of the third portion PA3 is projected to be more separated from the first end side ED1 than the sealant SE is. An end portion OE2 of the fourth portion PA4 is projected to be more separated from the second end side ED2 than the sealant SE is. Note that the position where the trap electrode TRE should be arranged is not particularly limited as long as the trap electrode TRE is arranged in an area corresponding to the pocket area PCK.

In the example illustrated, the display area DA is located outside the pocket area PCK, and part of the display area DA overlaps the aperture AP. However the display area DA may be located within the pocket area PCK. When the display area DA is located within the pocket area PCK, because the respective pixels PX and the trap electrode TRE are arranged close to each other within the range of not overlapping one another, the width of the frame of the non-display area NDA can be reduced.

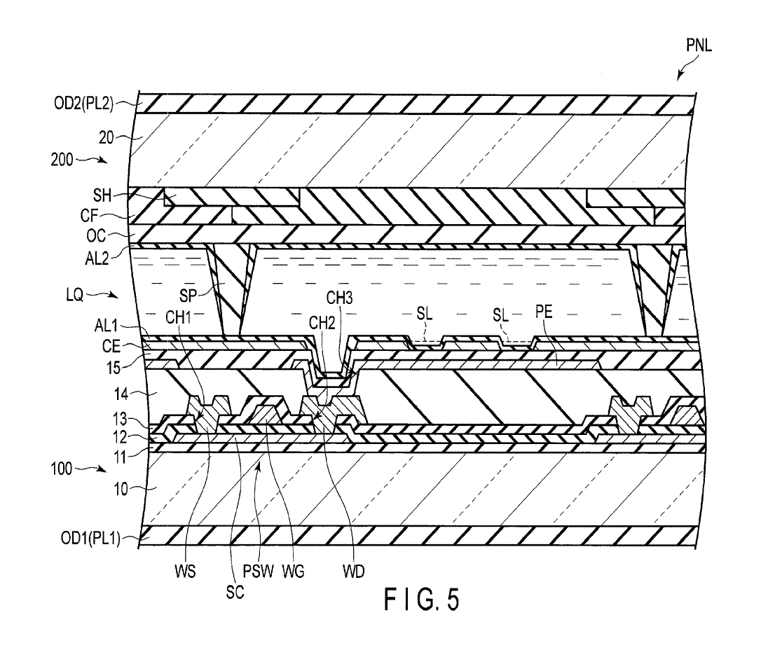

Data supply lines SIG extend in the second direction Y along the first end side ED1 in the non-display area NDA. The data supply lines SIG are arranged on the first substrate 100, and are routed up to a place around the second end side ED2 from the mount MT shown in FIG. 1. Also, the data supply lines SIG are formed by using, for example, at least one of an electrode layer in which a gate electrode WG is formed, and an electrode layer in which a source electrode and a drain electrode are formed, which are to be described later referring to FIG. 5. The data supply lines SIG include data supply lines of a fixed potential. Examples of the fixed potential to be applied to the data supply lines SIG are gate-high VGH and gate-low VGL applied to the gate electrode WG, and a common potential applied to the common electrode CE. Part of the data supply lines SIG to which is applied a fixed potential such as gate-high VGH or gate-low VGL is electrically connected to the scanning line driver GD.

The scanning line driver GD is arranged in the non-display area NDA, and is connected to the scanning line G illustrated in FIG. 2. For example, the scanning line driver GD generates a drive signal (a scanning signal) based on application of gate-high VGH or gate-low VGL from the data supply lines SIG, and outputs a control signal for toggling the state of the switching element PSW between conductive and non-conductive to the scanning line G. In the example illustrated, the data supply lines SIG and the scanning line driver GD are arranged closer to the display area DA than from the sealant SE. However, the arrangement is not limited to the illustrated example. When the display device DSP is of a type having a narrow frame, since the width of the non-display area NDA is small, at least part of the data supply lines SIG and the scanning line driver GD may overlap the sealant SE.

The potential of the trap electrode TRE should preferably be a fixed potential. For example, the trap electrode TRE is electrically connected to the data supply lines SIG of the fixed potential via a connecting portion CN. Alternatively, the trap electrode TRE may be electrically connected to the scanning line driver GD, and have applied to it a fixed potential of gate-high VGH or gate-low VGL via the scanning line driver GD. Also, after the potential of the trap electrode TRE has been kept at a fixed potential of a predetermined level for a predetermined period, the trap electrode TRE may be kept at a fixed potential of the other level.

FIG. 4 is an illustration showing an example of the structure of the connecting portion.

The illustrated example corresponds to a case where the connecting portion CN comprises a switching circuit SW for switching the fixed potential applied to the trap electrode TRE. Examples of the switchable fixed potential are gate-high VGH and gate-low VGL, but the other fixed potential may apply. The switching circuit SW receives a select signal SEL, and switches the fixed potential of a connection end of the trap electrode TRE between gate-high VGH and gate-low VGL. Since the trap electrode TRE can be connected to either of gate-high VGH of the positive potential and gate-low VGL of the negative potential, the potential of the trap electrode IRE can be either a positive fixed potential or a negative fixed potential. Note that the switching circuit SW can be incorporated into the scanning line driver GD, for example.

Next, referring to FIGS. 5 and 6, a cross-sectional structure of the display panel PNL will be described.

FIG. 5 is a drawing showing a cross-section of the display panel including pixels in the display area. In each of layers provided in the display panel PNL, the top (upward) is intended as the direction toward a front surface of the display panel PNL, and the bottom (downward) is intended as the direction toward a back surface of the display panel PNL.

The display panel PNL illustrated has a structure in which both of the pixel electrode PE and the common electrode CE are provided on the first substrate 100, and which is provided for a display mode mainly using a lateral electric field parallel to the substrate main surface. However, the display mode of the display panel PNL is not particularly limited, and the display panel PNL may have a structure provided for a display mode using a longitudinal electric field perpendicular to the substrate main surface, an oblique electric field inclined to the substrate main surface or a combination thereof. In the display mode using the longitudinal electric field or the oblique electric field, for example, a configuration in which the first substrate is provided with the pixel electrode PE and the second substrate 200 is provided with the common electrode CE can be applied.

The first substrate 100 comprises a first insulating substrate 10, the switching element PSW, the pixel electrode PE, the common electrode CE, a first insulating film 11, a second insulating film 12, a third insulating film 13, a fourth insulating film 14, a fifth insulating film 15, a first alignment film AL1, etc. In the illustrated example, the switching element PSW is a top-gate thin-film transistor having a single-gate structure, but may be of a double-gate structure, or a bottom-gate thin-film transistor.

The first insulating substrate 10 is formed of an insulating material having optical transmissivity such as glass or resin. The first insulating film 11 is disposed on the first insulating substrate 10, and covers the first insulating substrate 10. A semiconductor layer SC of the switching element PSW is formed on the first insulating film 11 in an island shape. The second insulating film 12 is formed on the first insulating film 11 and the semiconductor layer SC. The gate electrode WG of the switching element PSW is disposed on the second insulating film 12, and is opposed to the semiconductor layer SC via the second insulating film 12. The third insulating film 13 is formed on the second insulating film 12 and the gate electrode WG. A source electrode WS and a drain electrode WD of the switching element PSW are disposed on the third insulating film 13, and are electrically connected to the semiconductor layer SC through a first contact hole CH1 and a second contact hole CH2, respectively. The fourth insulating film 14 is disposed on the third insulating film 13, the source electrode WS, and the drain electrode WD. The pixel electrode PE is disposed on the fourth insulating film 14, and is electrically connected to the drain electrode WD via a third contact hole CH3. The fifth insulating film 15 is disposed on the fourth insulating film 14 and the pixel electrode PE. The first insulating film 11, the second insulating film 12, the third insulating film 13, and the fifth insulating film 15 are formed of an inorganic insulating material such as silicon nitride (SiN) or silicon oxide (SiO). The fourth insulating film 14 is formed of, for example, an organic insulating material. The common electrode CE is disposed on the fifth insulating film 15, and is opposed to the pixel electrode PE. At an area in which the common electrode CE is opposed to the pixel electrode PE, at least one slit SL is formed. The pixel electrode PE and the common electrode CE are formed of a transparent conductive material such as indium-tin-oxide (ITO) or indium-zinc-oxide (IZO). The first alignment film AL1 is disposed on the fifth insulating film 15 and the common electrode CE. In such a structure, the pixel electrode PE corresponds to a first electrode, and the common electrode CE corresponds to a second electrode.

In the example illustrated, although the common electrode CE is located closer to the liquid crystal layer LQ than from the pixel electrode PE, the pixel electrode PE may be located closer to the liquid crystal layer LQ than from the common electrode CE. In this case, the slit SL is formed in the pixel electrode PE. In this structure, the common electrode CE corresponds to a first electrode, and the pixel electrode PE corresponds to a second electrode. Also, the pixel electrode PE and the common electrode CE may be formed in a comb-like shape, and disposed in the same layer.

The second substrate 200 comprises a second insulating substrate 20, a light-shielding layer SH, a color filter CF, an overcoat layer OC, a spacer SP, and a second alignment film AL2.

The second insulating substrate 20 is formed of an insulating material having optical transmissivity such as glass or resin. The light-shielding layer SH is disposed on the lower surface side of the second insulating substrate 20. The color filter CF is located on the lower surface side of the second insulating substrate 20 and the light-shielding layer SH. End portions of the respective color filters CF overlap the light-shielding layer SH. While the color filters CF include, for example, a red color filter, a green color filter, and a blue color filter, they are not particularly limited. That is, the color filters CF may include a color filter of the other color such as white (colorless). It should be noted that the color filters CF may be formed in the first substrate 100.

The overcoat layer OC is disposed on the lower surface side of the color filters CF, and covers the color filters CF. The spacer SP is formed on the lower surface side of the overcoat layer OC, for example, and is projected toward the first substrate 100. The spacer SP is in contact with the first substrate 100, and maintains a gap between the first substrate 100 and the second substrate 200. In the example illustrated, while a distal end of the spacer SP directly contacts the first alignment film AL1, the second alignment film AL2 may be interposed between the spacer SP and the first alignment film AL1. Note that the spacer SP may include a main spacer and a subspacer. The main spacer contacts the first substrate 100 in the steady state, and maintains the gap. The subspacer is separated from the first substrate 100 in the steady state, and contacts the first substrate 100 when pressure force is applied to the display panel. Such a spacer SP may be formed on the first substrate 100, and projected toward the second substrate 200.

The second alignment film AL2 is disposed on the lower surface of the overcoat layer OC, and a surface of the spacer SP. The first alignment film AL1 and the second alignment film AL2 are formed of, for example, an organic material having horizontal alignment properties such as polyimide, and are subjected to an alignment treatment such as rubbing treatment or optical alignment treatment.

The liquid crystal layer LQ is held in the gap between the first substrate 100 and the second substrate 200. Liquid crystal molecules included in the liquid crystal layer LQ receive an alignment restriction force from the first alignment film AL1 and the second alignment film AL2 in a state in which no electric field is produced between the pixel electrode PE and the common electrode CE, and are initially aligned in a direction parallel to the main surfaces of the first substrate 100 and the second substrate 200.

A first optical element OD1 is disposed on the back surface side of the display panel PNL, and a second optical element OD2 is disposed on the front surface side of the display panel PNL. The first optical element OD1 comprises a first polarizer PL1, and the second optical element OD2 comprises a second polarizer PL2. The first polarizer PL1 and the second polarizer PL2 are arranged such that their absorption axes are perpendicular to each other, for example. Note that the first optical element OD1 and the second optical element OD2 may comprise the other functional layers such as a retardation film and a surface treatment layer.

FIG. 6 is a view showing a cross-section taken along line VI-VI′ of the display panel shown in FIG. 3. The trap electrode TRE is formed at a position opposed to the pocket area PCK, and is disposed, for example, on the fifth insulating film 15. Such a trap electrode TRE is formed of the same material as that of the common electrode CE illustrated in FIG. 5. Note that the trap electrode TRE may be disposed on the fourth insulating film 14 likewise the pixel electrode PE. However, since the trap electrode TRE increases the strength of an electric field which acts on the pocket area PCK, it should preferably be arranged near the liquid crystal layer LQ. Further, in the case of a display device DSP of a longitudinal electric field scheme such as a vertically aligned (VA) mode, the trap electrode TRE may be formed on the second substrate 200. In this case, the trap electrode TRE can be formed by the same material as that of the electrode formed on the second substrate 200.

The bank BA should preferably be arranged on the same substrate as the one on which the spacer SP shown in FIG. 5 is arranged. The bank BA is formed on the lower surface side of the overcoat layer OC of the second substrate 200, and is projected toward the first substrate 100. A top surface SFb of the bank BA located on the side close to the first substrate 100 is in contact with the first alignment film AL1. As in the space between the second insulating substrate 20 and the spacer SP in the display area DA shown in FIG. 5, in the space between the second insulating substrate 20 and the bank BA, the overcoat layer OC, the light-shielding layer SH, and the color filter CF are stacked. That is, likewise the spacer SP in the display area DA, the color filter CF which is illustrated has the function of adjusting the height of the bank BA so that the top surface SFb of the bank BA contacts the first alignment film AL1. Note that the second alignment film AL2 may be arranged between the top surface SFb and the first alignment film AL1.

The sealant SE is enclosed by the first substrate 100, the second substrate 200, and the bank BA on three sides. Also, in the example illustrated, at the first end side ED1 of the display panel PNL, an end portion of the sealant SE is at a position which overlaps the end portion of each of the first substrate 100 and the second substrate 200. The end portions are aligned because after forming a plurality of display panels PNL on a motherboard, the motherboard is cut with the sealant SE included to cut out the display panels PNL.

In an area where the fourth insulating film 14 overlaps the sealant SE, a groove portion GR is formed. The depth of the groove portion GR in a normal direction of the first substrate 100 and the width of the same in a direction parallel to the main surface of the first substrate 100 can be set as required. The sealant SE is filled inside the groove portion GR. Thereby, the volume of the sealant SE can be increased, and the strength of adhesion between the first substrate 100 and the second substrate 200 exerted by the sealant SE can be improved.

The groove portion GR penetrates the fourth insulating film 14. Also, each of the first alignment film AL1 and the second alignment film AL2 has an end portion at an area which overlaps the sealant SE. Because of the above structure, it is possible suppress entry of moisture into the liquid crystal layer LQ through the fourth insulating film 14, the first alignment film AL1, and the second alignment film AL2. Also, the groove portion GR may be formed in multiple places. By doing so, the contact area between the sealant SE and the first substrate 100 can be increased, thereby improving the strength of adhesion between the sealant SE and the first substrate 100.

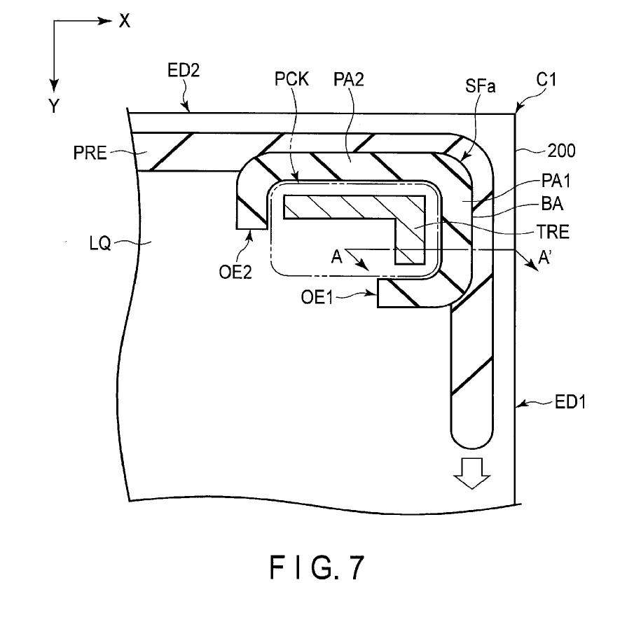

Next, referring to FIGS. 7 to 10, a process of bonding the first substrate 100 and the second substrate 200 by the sealant SE will be described. Note that in FIGS. 7 to 10, only the structures necessary for explanation are illustrated. The sealant SE is formed of a photosetting resin which is cured by radiation of ultraviolet (UV) light. Note that the sealant SE may be formed of a thermosetting resin which is cured by heat, or a photosetting/thermosetting combination resin whereby primary curing by heat is performed after temporary curing has been performed by UV radiation. In the following, a process of bonding when a sealant SE comprising the photosetting resin is applied will be described.

FIG. 7 is a plan view showing the second substrate in a process of applying a curable resin composition.

A curable resin composition PRE is a precursor of the sealant SE, and is a liquid having high viscosity which comprises a photosetting resin monomer, a polymerization initiator, a cross-linking agent, and various additives. Further, prior to the application of the curable resin composition PRE, apart from formation of the bank BA, a light-shielding layer, a color filter, an overcoat layer, and a spacer, not shown, are formed. In the application process, the curable resin composition PRE is applied to a surface of the second substrate 200. For example, when the curable resin composition PRE is drawn by using a dispenser, the curable resin composition PRE is applied along an outer peripheral surface of the second portion PA2 of the bank BA after it has been applied along the second end side ED2 in the non-display area NDA, and is further applied along an outer peripheral surface of the first portion PA1 of the bank BA, and then applied along the first end side ED1. Note that the way to apply the curable resin composition PRE is not limited to drawing using a dispenser, but may be printing using a printing plate or drawing using an ink jet.

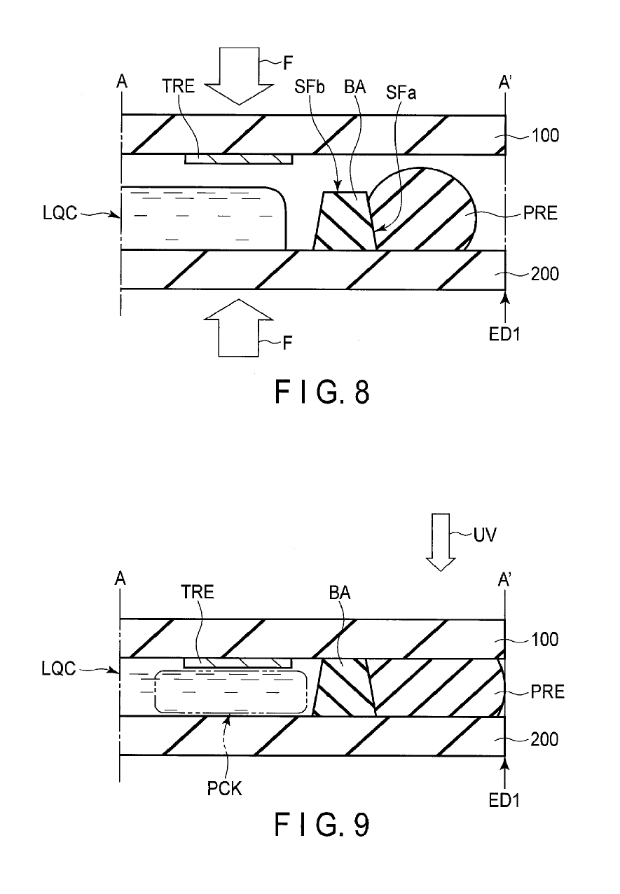

FIG. 8 is a view showing a cross-section of the display panel taken along line A-A′ shown in FIG. 7, in a process of aligning the first substrate and the second substrate.

In the present process, on the second substrate 200, a liquid crystal composition LQC which constitutes the liquid crystal layer LQ, and the curable resin composition PRE are mounted. The liquid crystal composition LQC is arranged more to the inner side as compared to where the curable resin composition PRE and the bank BA are arranged. The curable resin composition PRE should preferably not go over the bank BA, and at the stage of application, the curable resin composition PRE should preferably not arranged on the top surface SFb of the bank BA.

After aligning the first substrate 100 by making a surface on which the trap electrode TRE is mounted face the second substrate 200, the first substrate 100 and the second substrate 200 are adhered.

FIG. 9 is a view showing a cross-section of the display panel taken along line A-A′ shown in FIG. 7, in a UV radiation process.

As the first substrate 100 and the second substrate 200 are adhered to each other and pressurized, the liquid crystal composition LQC is spread between the first substrate 100 and the second substrate 200, and contacts the bank BA in the pocket area PCK. Meanwhile, the curable resin composition PRE is spread between the first substrate 100 and the second substrate 200 toward the outer side (i.e., toward the first end side ED1 illustrated in the drawing) from the bank BA, without going over the bank BA. After that, UV is irradiated on the curable resin composition PRE. The curable resin composition PRE irradiated with UV starts a polymerization reaction, and is cured. Through such a process, the sealant SE which bonds the first substrate 100 and the second substrate 200 is formed.

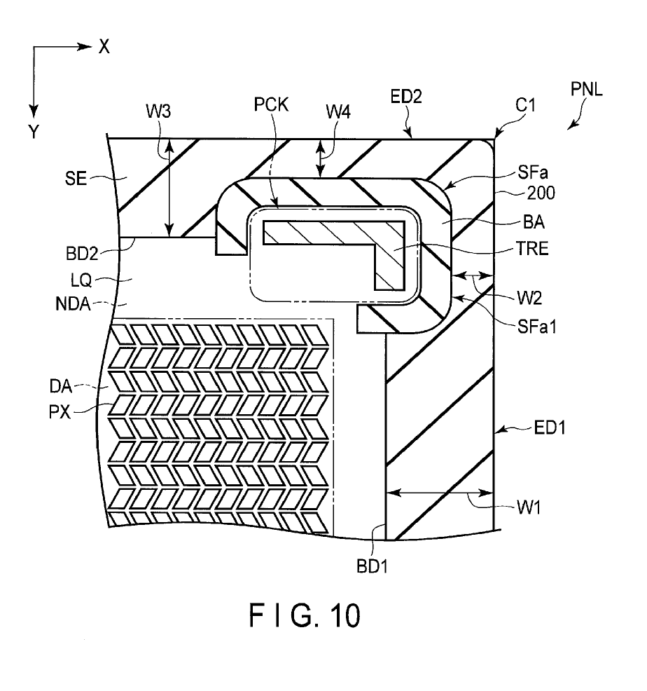

FIG. 10 is a plan view showing the display panel after the curable resin composition has been cured.

The sealant SE extending along the first end side ED1 includes width W1, which corresponds to a dimension from border BD1 between the sealant SE and the liquid crystal layer LQ to an outer end portion of the sealant SE laterally, and width W2, which corresponds to a dimension from a border between the sealant SE and the bank BA (or an outer peripheral surface of the bank BA) to the outer end portion. Width W1 is greater than width W2. In the example illustrated, although the outer end portion of the sealant SE overlaps the first end side ED1, it may be positioned on the inner side as compared to the first end side ED1.

The sealant SE extending along the second end side ED2 includes width W3, which corresponds to a dimension from border BD2 between the sealant SE and the liquid crystal layer LQ to an outer end portion of the sealant SE laterally, and width W4, which corresponds to a dimension from a border between the sealant SE and the bank BA (or an outer peripheral surface of the bank BA) to the outer end portion. Width W3 is greater than width W4. In the example illustrated, although the outer end portion of the sealant SE overlaps the second end side ED2, it may be positioned on the inner side as compared to the second end side ED2.

As described above, according to the present embodiment, the display device DSP comprises the trap electrode TRE disposed in the non-display area NDA, and the bank disposed between the sealant SE and the trap electrode TRE. The trap electrode TRE can capture ionic impurities of the liquid crystal layer LQ which cause a black spot. By capturing the ionic impurities in the non-display area NDA, condensation of the ionic impurities in the display area DA can be obstructed. Since the bank BA can restrict spreading of the curable resin composition PRE for forming the sealant SE, the pocket area PCK for an ion trap can be formed at a part of an area where the sealant SE should be arranged. Accordingly, even if the non-display area NDA is reduced in accordance with a demand for a narrower frame structure of the display device DSP, it is possible to secure a pocket area PCK of a sufficient volume to accommodate the ionic impurities in the non-display area NDA. That is, according to the present embodiment, a display device DSP capable of suppressing the deterioration in display quality without interfering with narrowing of the frame can be provided.

Further, on the outer side of the bank BA, the sealant SE is arranged continuously. Also, since the sealant SE is in contact with an outer peripheral surface SFa of the bank BA, a sufficient contact area can be secured for the sealant SE. Accordingly, with respect to the display device DSP, it is possible to prevent the strength of adhesion between the first substrate 100 and the second substrate 200 from being reduced as a result of arranging the bank BA. In addition, by forming the groove portion GR in the substrate, the contact area of the sealant SE and the volume of the sealant SE are increased, thereby improving the strength of adhesion. As described above, the display device DSP can prevent the reliability from being decreased due to insufficient strength of adhesion between the first substrate 100 and the second substrate 200.

As the potential of the trap electrode TRE is set to, for example, a positive fixed potential, ionic impurities having negative charges can be captured in the pocket area PCK. Alternatively, as the potential of the trap electrode TRE is set to, for example, a negative fixed potential, ionic impurities having positive charges can be captured in the pocket area PCK.

Since the trap electrode TRE is electrically connected to the data supply lines SIG which apply a fixed potential to the scanning line driver GD, in the non-display area of a narrow frame, there is no need to further arrange a conductive line for applying the fixed potential to the trap electrode TRE.

Further, since the switching circuit SW for switching the fixed potential to be applied to the trap electrode TRE is provided, the display device DSP can suppress non-uniformity in display which results from ionic impurities regardless of whether they have negative or positive charges. In addition, the fixed potential to be applied to the trap electrode TRE can be switched while the display device DSP is being driven.

Also, since the bank BA and the spacer SP are formed on the same substrate, the bank BA and the spacer SP can be formed simultaneously by using the same material. Thus, a separate manufacturing process for forming the bank BA is not required, and the manufacturing cost can be prevented from increasing.

Also, the bank BA is projected such that it is projected toward the liquid crystal layer as compared to a border between the sealant SE and the liquid crystal layer LQ. In this way, it is possible to prevent the sealant SE from being formed in the pocket area PCK surrounded by the bank BA, and prevent the area of the pocket area PCK from being reduced.

The trap electrode TRE comprises the bent portion BP, the first extended portion EP1, and the second extended portion EP2, and is formed in the shape of L. By arranging the trap electrode TRE at a position which is close to the first corner portion C1 and far from the aperture AP, in the pocket area PCK, the ionic impurities can be captured a lot in the pocket area PCK.

In the following, modifications of the present embodiment will be described. Note that also in each of the modifications, an advantage similar to that of the present embodiment can be obtained.

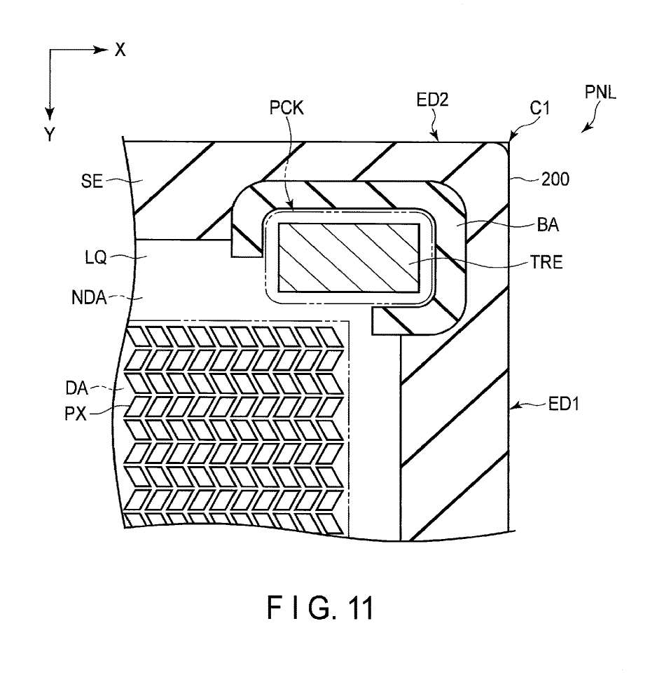

FIG. 11 is a view which shows a display panel of a modification in which the shape of the trap electrode is different.

This modification is different from the structural example illustrated in FIG. 10 in that the shape of the trap electrode TRE is polygonal. The trap electrode TRE is a rectangle having long sides in the first direction X when the X-Y plane is seen in planar view. In the present modification, the trap electrode TRE is arranged such that it occupies the pocket area PCK as much as possible.

In the present modification, since the area of the trap electrode TRE is large, the ionic impurities electrically attracted to an area opposed to the trap electrode TRE can be captured in the pocket area PCK a lot.

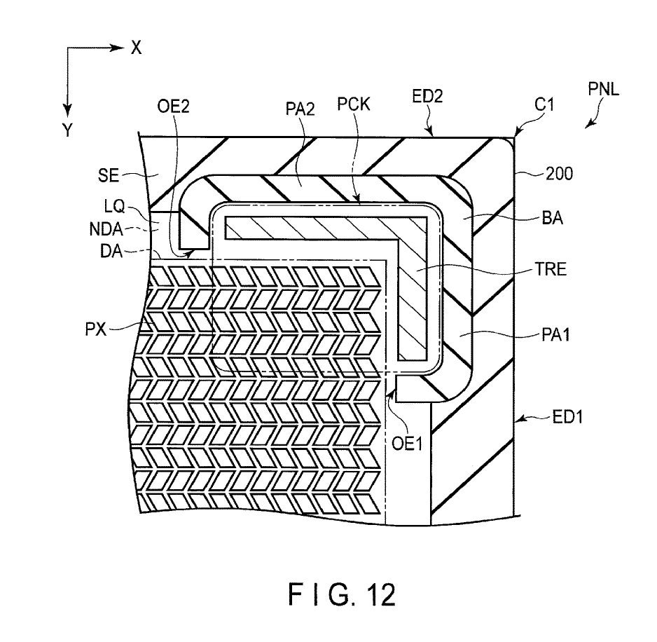

FIG. 12 is a view which shows a display panel of a modification in which the positions of the trap electrode and the bank are different.

This modification is different from the structural example illustrated in FIG. 10 in that part of the display area DA (pixels PX) is located within the pocket area PCK. The first extended portion EP1 of the trap electrode TRE is located between the display area DA and the first portion PA1 of the bank BA in the direction parallel to the second end side ED2, and the second extended portion EP2 is located between the display area DA and the second portion PA2 of the bank BA in the direction parallel to the first end side ED1. Here, the end portion OE1 of the bank BA is opposed to the display area DA in the first direction X, and the end portion OE2 is opposed to the display area DA in the second direction Y.

In the present modification, even if the display device DSP is structured to have an even more narrowed frame and the area of the non-display area NDA is reduced, the ionic impurities can be sufficiently captured in the non-display area NDA, and occurrence of the non-uniformity in display of the display device DSP can be suppressed.

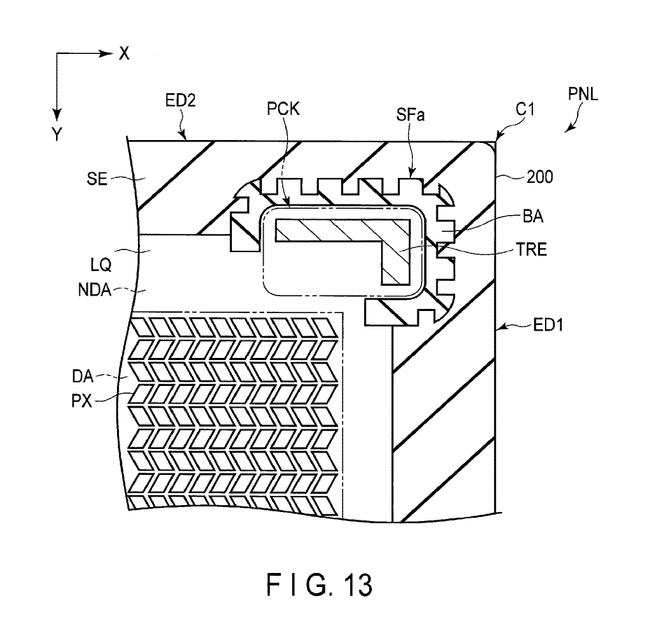

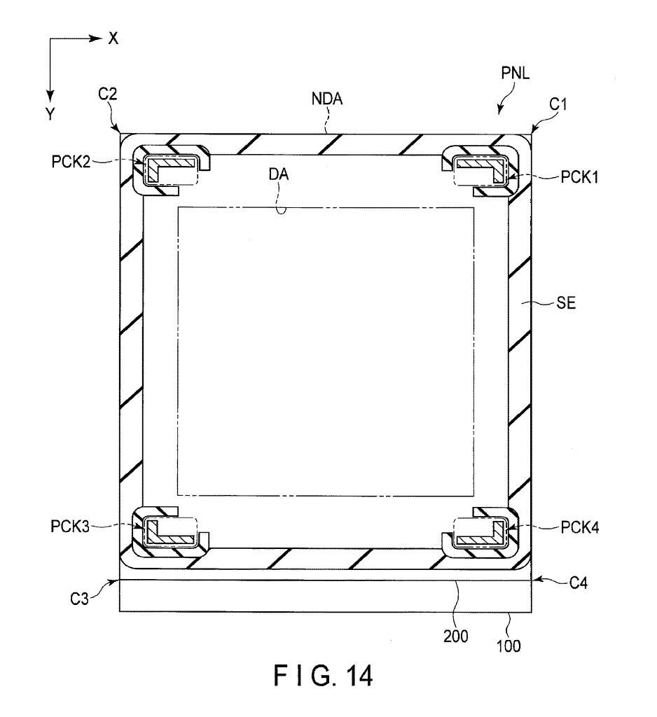

FIG. 13 is a view which shows a display panel of a modification in which the shape of the bank is different.

This modification is different from the structural example illustrated in FIG. 10 in that the bank BA has the outer peripheral surface SFa having a convex-concave shape. By applying the bank BA having the outer peripheral surface SFa of the convex-concave shape, the contact area between the sealant SE and the bank BA can be increased. In this way, the strength of adhesion between the sealant SE and the outer peripheral surface SFa is improved, thereby preventing a peel between the first substrate 100 and the second substrate 200 from occurring from the first corner portion C1.

Next, referring to FIGS. 14 to 16, modifications regarding the arrangement of the bank BA and the trap electrode TRE will be described.

Note that the bank BA and the trap electrode TRE are not necessarily arranged near the first corner portion C1, but may be arranged near the second corner portion C2, the third corner portion C3, or the fourth corner portion C4. Even if the bank BA and the trap electrode TRE are those formed near the second corner portion C2, the third corner portion C3, or the fourth corner portion C4, an advantage similar to that obtained by the bank BA and the trap electrode TRE formed near the first corner portion C1 can be obtained.

FIG. 14 is a view showing an example of the arrangement of the trap electrode and the bank.

In the present modification, a first pocket area PCK1 is arranged near the first corner portion C1, a second pocket area PCK2 is arranged near the second corner portion C2, a third pocket area PCK3 is arranged near the third corner portion C3, and a fourth pocket area PCK4 is arranged near the fourth corner portion C4. Note that each of the first to fourth pocket areas PCK1 to PCK4 has the trap electrode TRE, and the bank BA which has the aperture AP on the side the display area DA is provided and is disposed around the trap electrode TRE.

In the present modification, since the bank BA and the trap electrode TRE are provided in the vicinity of all of the first corner portion C1 to the fourth corner portion C4, occurrence of non-uniformity in display can be suppressed regardless of in which corner of the display device DSP the ionic impurities condense.

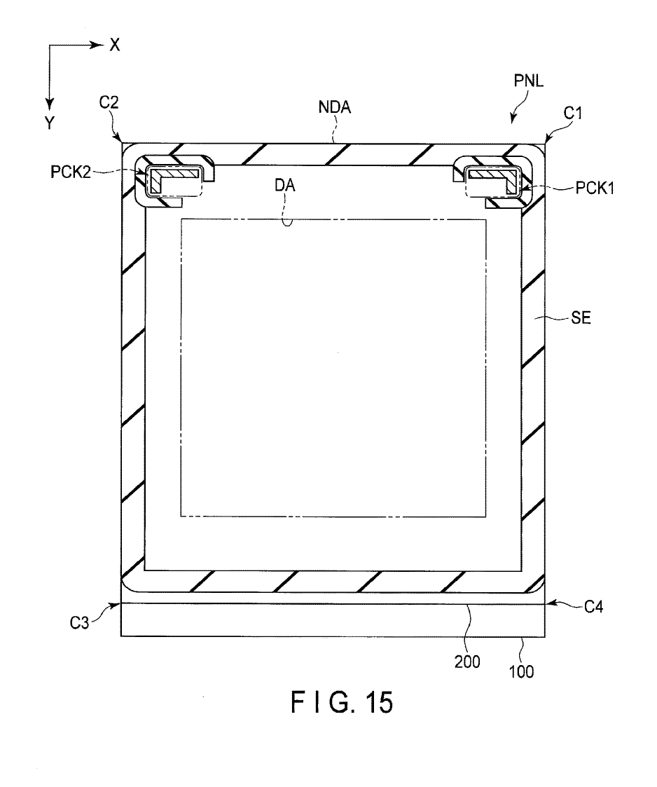

FIG. 15 is a view showing a modification in which the trap electrodes and the banks are disposed on an end side on the opposite side of the mount. In the present modification, the bank BA and the trap electrode TRE are provided near each of the first corner portion C1 and the second corner portion C2.

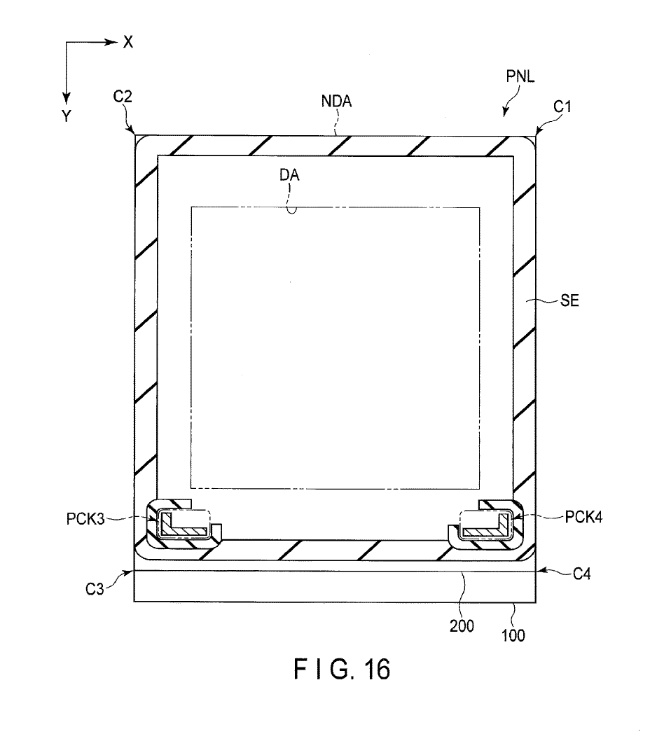

FIG. 16 is a view showing a modification in which the trap electrodes and the banks are disposed on an end side close to the mount. In the present modification, the bank BA and the trap electrode TRE are provided near each of the third corner portion C3 and the fourth corner portion C4.

As in the modifications illustrated in FIGS. 15 and 16, because the bank BA and the trap electrode TRE are provided on both ends of an end side where the ionic impurities tend to condense, occurrence of non-uniformity in display can be suppressed effectively.

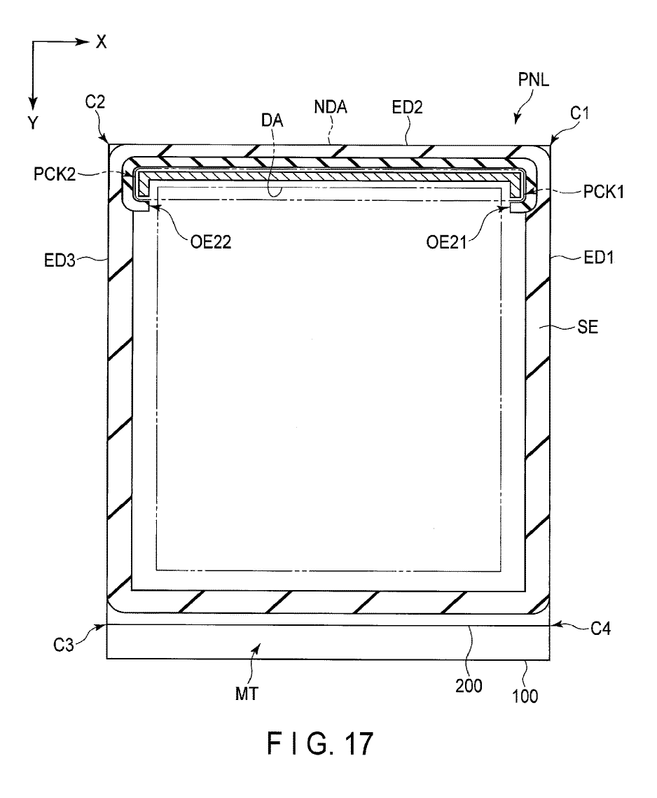

FIG. 17 is a view showing a modification in which the trap electrode and the bank are each formed integrally from the first corner portion to the second corner portion along the end side.

This modification is different from the modification illustrated in FIG. 15 in that the first pocket area PCK1 and the second pocket area PCK2 are formed continuously along the second end side ED2 corresponding to the opposite side. The bank BA has a rectangular shape with rounded corners having a long side in the direction parallel to the second end side ED2, and has an aperture in the opposed long side, which is the side closer to the mount MT. An end portion OE21 of the bank BA positioned near the first corner portion C1 is opposed to the display area DA in the direction parallel to the second end side ED2. An end portion OE22 of the bank BA positioned near the second corner portion C2 is opposed to the display area DA in the direction parallel to the second end side ED2, and is opposed to the end portion OE21. The trap electrode TRE is U-shaped such that it has an aperture which is open on the side the mount MT is provided, and is located between the display area DA and the bank BA.

According to the present modification, as compared to a case where the bank BA and the trap electrode TRE are formed only at the first corner portion C1 or the second corner portion C2, a larger trap electrode TRE can be disposed in the display device DSP. Therefore, the display device DSP of this modification can capture a greater amount of ionic impurities. That is, even with a display device DSP having a narrow frame, occurrence of non-uniformity in display can be sufficiently suppressed.

As described above, a display device capable of suppressing the deterioration in display quality without interfering with narrowing of the frame can be provided by the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device including a display area and a non-display area, the display device comprising:
a first substrate;
a second substrate arranged to be opposed to the first substrate;
a sealant which bonds the first substrate and the second substrate;
a liquid crystal layer held between the first substrate and the second substrate and sealed by the sealant;
a trap electrode positioned at an inner side surrounded by the sealant and arranged in the non-display area; and
a bank disposed between the sealant and the trap electrode.

2. The display device of claim 1, wherein a potential of the trap electrode is a fixed potential.

3. The display device of claim 1, further comprising:
a driver which is arranged in the non-display area and supplies a drive signal necessary for driving each pixel of the display area; and
a data supply line which is arranged in the non-display area and applies a fixed potential to the driver, wherein
the trap electrode is electrically connected to the data supply line.

4. The display device of claim 3, wherein the fixed potential is a gate-high or gate-low potential applied to a gate electrode of each pixel.

5. The display device of claim 3, wherein the driver comprises a switching circuit which switches the fixed potential applied to the trap electrode when a select signal is received.

6. The display device of claim 5, wherein the fixed potential of the trap electrode is switched between a positive potential and a negative potential by the switching circuit.

7. The display device of claim 1, further comprising a spacer which is formed in the display area and maintains a space between the first substrate and the second substrate, wherein
the bank is formed on a same substrate as the one the spacer is formed on.

8. The display device of claim 1, wherein the bank is projected such that it is projected toward the liquid crystal layer as compared to a border between the sealant and the liquid crystal layer.

9. The display device of claim 1, wherein:
the display device further comprises a corner portion which is formed by a first end side and a second end side extending in directions which cross each other; and
the trap electrode is arranged near the corner portion.

10. The display device of claim 9, wherein the sealant extending along the first end side includes a first width, which corresponds to a dimension from a border between the sealant and the liquid crystal layer to an outer end portion of the sealant, and a second width, which corresponds to a dimension from a border between the sealant and the bank to the outer end portion, and the first width is greater than the second width.

11. The display device of claim 1, wherein the trap electrode is L-shaped or polygonal.

12. The display device of claim 1, wherein the bank has an outer peripheral surface having a convex-concave shape.

13. The display device of claim 1, wherein:
the first substrate comprises, in the display area, a first electrode, an insulating film disposed on the first electrode on the liquid crystal layer side of the first electrode, a second electrode disposed on the insulating film on the liquid crystal layer side of the insulating film, and a switching element electrically connected to the first electrode or the second electrode; and
the trap electrode is disposed on the insulating film on the liquid crystal layer side of the insulating film, and is formed of a same material as that of the second electrode.

14. A display device comprising:
a display panel including a display area on which an image is displayed, and a frame-shaped non-display area located around the display area;
a sealant arranged in the non-display area of the display panel;
a liquid crystal layer sealed within the display panel by the sealant;
a mount arranged on one of short sides of the display panel;
a first corner portion and a second corner portion located on a opposite side of the mount side of the display panel;
a third corner portion and a fourth corner portion located on the mount side of the display panel;
a first bank which is located near at least one of the first to fourth corner portions of the non-display area, and includes an aperture at a position opposed to the display area, and an outer peripheral surface which is in contact with the sealant;
a first pocket area surrounded by the first bank in the liquid crystal layer; and
a first trap electrode disposed in an area corresponding to the first pocket area at the non-display area.

15. The display device of claim 14, further comprising:
a driver which is arranged in the non-display area and supplies a drive signal necessary for driving each pixel of the display area; and
a data supply line which is arranged in the non-display area and applies a fixed potential to the driver, wherein
the first trap electrode is electrically connected to the data supply line.

16. The display device of claim 14, wherein the display area is located outside the first pocket area, and overlaps the aperture.

17. The display device of claim 14, wherein the display area overlaps the first pocket area.

18. The display device of claim 14, further comprising:
a second bank which is located near at least one of the first to fourth corner portions of the non-display area;
a second pocket area surrounded by the second bank in the liquid crystal layer; and
a second trap electrode disposed in an area corresponding to the second pocket area at the non-display area, wherein
the first pocket area is located the first corner portion, and
the second pocket area is located the second corner portion.

19. The display device of claim 14, further comprising:
a second bank which is located near at least one of the first to fourth corner portions of the non-display area;
a second pocket area surrounded by the second bank in the liquid crystal layer; and
a second trap electrode disposed in an area corresponding to the second pocket area at the non-display area, wherein
the first pocket area is located the third corner portion, and
the second pocket area is located the fourth corner portion.

20. The display device of claim 14, further comprising:
a second bank which is located near at least one of the first to fourth corner portions of the non-display area;
a second pocket area surrounded by the second bank in the liquid crystal layer; and
a second trap electrode disposed in an area corresponding to the second pocket area at the non-display area, wherein
the first and pocket area is located the first corner portion,
the second pocket area is located the second corner portion, and
the first and second pocket areas are arranged continuously along the opposite side of the display panel.
